(19) United States
(12) Patent Application Publication
(10) Pub. No.: US 2007/0022155 A1
(43) Pub. Date: Jan. 25, 2007

(54) Method and system for integrating enterprise software applications with desktop software applications

(76) Inventors: David H. Owens, San Jose, CA (US); Philip C. Nelson, San Jose, CA (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 10/262,810

(22) Filed: Oct. 1, 2002

Related U.S. Application Data
(60) Provisional application No. 60/405,434, filed on Aug. 22, 2002.

(51) Int. Cl. G06F 15/16

(52) U.S. Cl. 709/202

(57) ABSTRACT

One or more server-based constructs are projected into one or more corresponding desktop objects. Thereafter one or more events involving the desktop objects are processed according to behaviors defined during the projection using action handlers cached at a desktop client. The action handlers provide a mechanism for instituting the server-defined behaviors at the desktop, including the playing of locally cached web forms that provide a user with options for interacting with the desktop objects according to those behaviors. Any or all interactions with the desktop objects may be subsequently communicated to the server, which can accept or reject any changes and resynchronize an updated view of the object(s) to the desktop client.

### RELATED APPLICATIONS

This application is related to and hereby claims the priority benefit of co-pending U.S. Provisional Application No. 60/405,434, entitled “Method and System for Integrating Enterprise Software Applications with Desktop Software Applications”, filed Aug. 22, 2002 by the present inventors.

### FIELD OF THE INVENTION

The present invention relates to a scheme for integrating enterprise software applications with traditional single-user (i.e., desktop) software applications, such as the Microsoft Office™ suite of software applications.

### BACKGROUND

Desktop software applications are designed primarily for local, single-user interaction. Such applications include many popular software titles designed for personal computers. Among these applications are the Microsoft Office suite of products that includes Microsoft Word™ (a word processing application), Outlook™ (a personal calendar and e-mail tool), Excel™ (a spreadsheet application) and others. Because these desktop applications are resident on a user's personal computer, they (and the documents, spreadsheets and other objects associated therewith) are available even when the user is not connected to a computer network. That is, these applications are available when the user is “off-line”.

Enterprise applications, on the other hand, typically reside on one or more servers accessible via a computer network and make use of large, often shared, databases. Examples of enterprise applications include software applications for customer resource management; payroll, accounting and human resource functions; and other business processes. In general, these applications are designed for multi-user use and include features and facilities that allow for common views of data across an entire business enterprise. In some cases, access to the enterprise application can occur via a private communication channel set up across a public network or network of networks (e.g., the Internet). Nevertheless, these enterprise applications have user interfaces that are limited either to specialized client programs (“fat clients”), or to online Internet browser displays (“thin clients”). The enterprise application may also send notification e-mails with links that can be followed back to the server. As such, the enterprise application is simply not available when the user is not connected to a network.

More and more, software application users have to alternate between using enterprise applications and desktop applications to accomplish workday tasks. Indeed, in the modern business environment users spend much of their time making use of rich desktop applications, managing multiple information sources such as mail, calendars, tasks, word processing documents, spreadsheets, and so on. However, the enterprise applications that these users also must access are not linked to this desktop. Consequently, documents and spreadsheets created and/or manipulated by the user in the desktop environment are disconnected from application server(s) hosting the enterprise application(s) and, hence, are inaccessible to others. Further, time sensitive matters may not be present on a user's calendar, action items assigned by others may not appear on the user's task list, and there is no connection between the calendar items and/or tasks and the actual documents requiring attention.

In short, because enterprise applications are not integrated with the desktop environment, users cannot work productively offline. Even simple actions, such as updating status or looking up a critical value, require live connection to servers. Moreover, when utilizing the enterprise applications, users cannot leverage the rich features of their various (and familiar) desktop tools, such as spreadsheets for data entry, manipulation and presentation, or their personal calendar for scheduling.

Others have attempted to address some of these issues by providing for network-based functionality within documents and spreadsheets that can be opened using desktop applications. For example, U.S. Patent Application 2002/0065849, published May 30, 2002, (hereinafter “the '849 application”) describes a scheme by which desktop applications may be augmented so that documents created thereby can include content extracted from a network-based resource. According to this patent application, as changes to the content occur at the network-based resource, these changes are reflected in the desktop document in which the content link is provided. This scheme appears to have been commercialized to some extent in the so-called “Juice Platform” available from Juice Software, Inc. of New York, N.Y. (see, e.g., Alan C. Warren, “The Juice Platform—Architecture and Applications”, Juice Software, Inc., October 2001).

The example cited in the '849 application involves the inclusion of up-to-date stock price quotations within a document or spreadsheet. Using the Juice technology, one can construct a document having a field that is linked to a server configured to provide up-to-date stock quotes. In this way, as the stock price information is updated at the server these updates are reflected in the document, provided the desktop environment in which the document is open is communicatively coupled to the server.

This type of integration is useful where the goal is to synchronize information on a server with information in a spreadsheet in real time. However, a different approach is required if one wishes to project a complete range of server-based information and interactions to the desktop, and in a way where a wide range of interactions are possible when the user is not online. In other words, something more than just synchronization is needed if one wishes to apply server-defined behaviors associated to downloaded or synchronized objects on the desktop.

### SUMMARY OF THE INVENTION

In one embodiment, the present invention provides a method and system for projecting one or more server-based constructs into one or more corresponding desktop objects. Thereafter one or more types of interactions with the desktop objects are processed according to behaviors defined during the projection. These interactions with the desktop objects are subsequently communicated to the server. The interactions may include manipulation of the one or more objects with the one or more desktop applications at a time when the desktop applications are not communicatively coupled to an enterprise application hosted by the server. The interactions with the desktop objects may be communicated to the enterprise application via extensible markup language (XML) messages. The XML messages may comprise e-mail attachments, and may be sent via a secure communication channel.

The behaviors defined during the projection are processed according to action handlers cached at a desktop client. The desktop client is itself integrated with one or more of the desktop applications. The action handlers may be configured to save, modify or create an associated object; launch a desktop application; send a message to the enterprise application; provide a link back to the enterprise application; and/or present a locally cached web form at the desktop. Such locally cached web forms provide a user with options for interacting with the desktop objects according to the behaviors defined by the enterprise application. Further, in some cases the action handlers may manipulate the desktop objects to alter the desktop environment without communicating such manipulation to the enterprise application.

Single ones of the constructs of the enterprise application may be projected to multiple ones of the corresponding objects associated with the desktop applications. In other cases, a single enterprise application construct is projected to a corresponding object associated with multiple ones of the desktop applications. In still other cases, multiple enterprise application constructs are projected to a single corresponding object associated with the desktop applications.

Another embodiment of the present invention provides a system having a client application configured to (i) recognize events corresponding to manipulations of objects within one or more desktop applications within a desktop environment, and (ii) invoke one or more action handlers to respond to the events according to behaviors defined by an enterprise application; and a web service instantiated at a server remote from the desktop environment and including a message processor that enables receipt and transfer of messages between the client application and the enterprise application resident at the server. The web service may be configured to provide one or more web forms to the client application, which web forms can be subsequently played by the action handlers within the desktop environment in response to the recognized events. The web forms generally comprise server behavior-defined options for managing the objects according to the events.

One or more of the messages between the client application and the enterprise application may comprise updates reflecting changes to the objects made within the desktop environment. The enterprise application is configured to accept or reject the changes to the objects and to communicate such acceptance or rejection to the client application. Communication of this acceptance or rejection may include a complete or partial description of objects related or unrelated to a changed object.

Yet another embodiment of the present invention involves receiving XML representations of enterprise application-based objects along with enterprise application-defined behaviors for these objects within a desktop environment; projecting the XML representations of the objects as one or more desktop application objects within the desktop environment; recognizing events associated with the desktop application objects occurring within the desktop environment; and invoking action handlers representing the defined behaviors for the objects. The action handlers may perform any or all of the above-described functions. Still other embodiments of the present invention provide for converting a representation of an object associated with an enterprise application resident at a server from a native representation of the object in the enterprise application to an XML representation of the object; and projecting the XML representation of the object along with enterprise application-defined behaviors for the object to a desktop environment remote from the server. The behaviors are subsequently instantiated as action handlers within the desktop environment, and the action handlers may be invoked when associated events occur within the desktop environment.

### BRIEF DESCRIPTION OF THE DRAWINGS

The present invention is illustrated by way of example, and not limitation, in the figures of the accompanying drawings, in which:

FIG. 1 illustrates the use of a client plug-in and corresponding server-based web service in accordance with one embodiment of the present invention.

FIG. 2 illustrates an object manipulation—event recognition—action handler response form of processing for desktop application objects performed in accordance with an embodiment of the present invention.

FIG. 3 illustrates an example of the basic process flow of FIG. 2 in the context of a Microsoft Outlook object in accordance with an embodiment of the present invention.

FIG. 4 illustrates an example of the basic process flow of FIG. 2 in the context of a Microsoft Excel object in accordance with an embodiment of the present invention.

FIG. 5 illustrates an example of the basic process flow of FIG. 2 in the context of a Microsoft Word object in accordance with an embodiment of the present invention.

### DETAILED DESCRIPTION

In one embodiment, the present invention provides a method and system for projecting one or more server-based constructs into one or more corresponding desktop objects. Thereafter one or more types of interactions with the desktop objects are processed according to behaviors defined during the projection. These interactions with the desktop objects are subsequently communicated to the server. In such an embodiment, the present invention may be instantiated as computer software (i.e., one or more instructions for execution by one or more computer processors) resident on a computer-readable medium or otherwise, which, when executed by the computer processor(s), cause the processor(s) to perform actions in accordance therewith. Utilizing the present invention, one is able to connect the otherwise disconnected environments of server-based enterprise applications and desktop applications.

As will become evident from the description below, the present invention leverages the best of both the desktop application environment and the enterprise application environment. The enterprise server remains the central point for administration and control, but users interact with the enterprise application through familiar desktop tools. Rather than simply presenting a scaled-down version of an enterprise application (e.g., through a customized interface) in an off-line environment, the present invention allows users to employ the full power of the desktop applications (for example using Excel for data presentation and entry, and Outlook as a calendar) when manipulating objects such as calendar items, spreadsheets and documents. Further, common tasks that do not need a live server connection are available off-line. With the present invention, information that is normally bottled up in an enterprise application can be projected and synchronized on to the desktop as native tasks, folders, calendar events, spreadsheets, etc. The present invention enhances these native objects to make them fully actionable, even when the user is off-line, based on behaviors specified by the enterprise application.

As used in the context of the present invention, the terms enterprise application and application server are not meant to be limited to hardware and software products currently marketed under such names by their developers. Instead, what is meant is a platform that hosts a software application that is available to a number of (often, though not exclusively, concurrent) users and which includes or makes use of a common data source. Thus, included in such terms are software applications hosted by computer systems accessible through a local area network, wide area network, home network or even a network of networks such as the Internet.

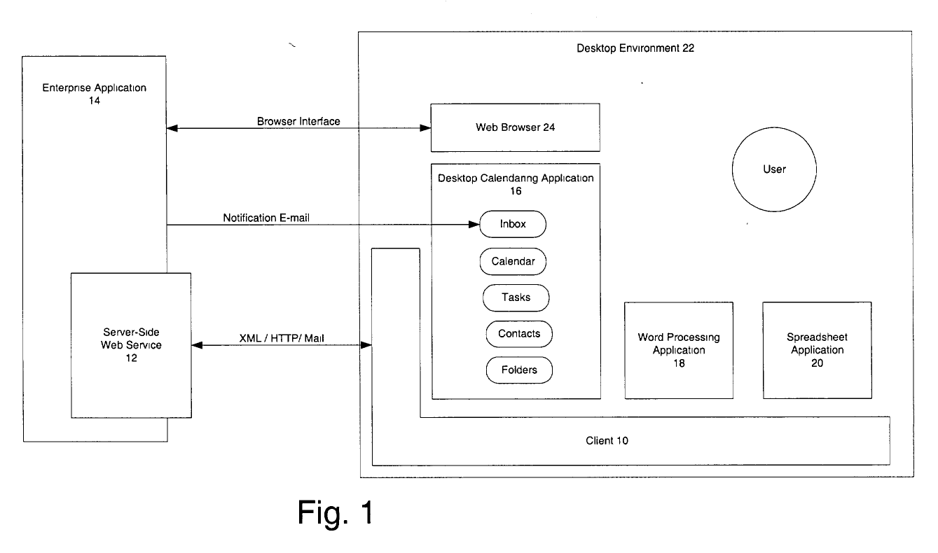

As illustrated in FIG. 1, one embodiment of the present software has two components: a client plug-in 10 and a web service extension 12 to an existing enterprise application 14. Client 10 may be regarded as a plug-in that integrates into desktop applications such as a desktop calendaring application 16 (e.g., Microsoft Outlook), a word processing application 18 (e.g., Microsoft Word), and/or a spreadsheet application 20 (e.g., Microsoft Excel) running on a desktop environment 22 (e.g., Microsoft Windows). The client 10 permits web-based installation as well as login and authentication for user access. Operating in connection with the client application 10 are various scripts that assist a user in building web forms enabling the action handlers described below.

One of the main benefits of web-based applications (e.g., enterprise applications available through a browser-based interface) is that a web browser 24 running on the desktop 22 acts as a generic “player” of presentation, data, and scripts, managed from and sent by the application server hosting the enterprise application as web pages. As the enterprise application is (re)configured and its functionality evolves, changes on the application server are automatically reflected in the client (i.e., the browser) as it “plays” a new set of pages. This is true of web browsers and is also true of many other “players” such as Adobe's Acrobat™ and Macromedia's Flash™. The code of the “player” also evolves (e.g., as new functionality is provided to the browser, etc.) but much less often than the enterprise application. As will be seen from the description below, client 10 is such a “player”, allowing various application objects and action handlers to be “played” on the desktop based on instructions from the enterprise application 14 and in response to events that are recognized when objects are manipulated in the desktop environment 22.

In order to provide such features, the client 10 performs the following primary functions:
(i) Communication: Client 10 manages bi-directional synchronization of objects, policy, and behaviors between the enterprise application 14 and the desktop 22. This information can be represented in various forms including an XML description of the objects and the policy, and behaviors specified as dynamic hypertext markup language (DHTML)-based interfaces (e.g., web forms that may be locally cached at the desktop) or in other desktop scripting languages (e.g. JavaScript or VBScript) that can be processed on the desktop 22.
(ii) Handling of Desktop Objects: Client 10 interacts with and manipulates desktop applications and the desktop operating system to create, modify, and delete local objects (e.g., tasks, calendar events, menu buttons, folders, document properties, spreadsheet cell values and properties, and named regions of information). For example, the enterprise application 14 may request that the client 10 create a new menu item and several new calendar events, modify the contents of a folder, and make available new data to be loaded into a spreadsheet. Each of these objects may also include descriptions of the desired behavior when the user manipulates these objects on the desktop 22.
(iii) Monitoring Events and Running Action Handlers: Client 10 monitors and reacts to any user interactions with the local desktop objects (e.g., rescheduling of an appointment, checking off a task as it is completed, opening, closing or saving a document, editing a spreadsheet cell, etc.) by running one or more corresponding action handler(s) (e.g., to launch another desktop application, save a document, send a message, launch a browser back to the server, create or edit desktop objects, etc). Where so required by the action handler(s), client 10 provides a controlled and secure environment to interact locally with the user using a conventional web browser (or other desktop script processing engine) over presentation rules and scripts provided by the enterprise application 14. This latter response is referred to herein as playing or presenting locally cached web forms.

Thus, client 10 allows for interacting with desktop objects according to behaviors defined by the enterprise application 14. These behaviors are represented by action handlers, which are cached locally at the client 10 so they can be utilized when the user is off-line. The action handlers can provide for many different operations, for example, the playing of locally cached web forms to be completed by the user. The forms can be “played” by client 10 in a local web browser when certain events (e.g., manipulations of desktop objects) are recognized as having occurred. The client 10 extends the browser hosted script environment available to the form designer to provide access to the underlying desktop objects and any extended data attributes projected from the enterprise application, to allow manipulations of those objects, to send secure messages back to the enterprise application 14, and to access any other desktop capabilities allowed within the existing security models.

Server-Side Web Service 12 may be regarded as an extension to an enterprise application and includes a message processor that enables the receipt and transfer of (optionally) encrypted messages (using XML, HTTP and/or e-mail messages) between the client 10 and the enterprise application 14. In other words, the server-side web service 12 facilitates communication with the client 10. Operating in connection with the server-side web service 12 are various server-side scripts that may be regarded as tools that assist users in building web forms enabling the action handlers mentioned above.

The server-side web service 12 may be implemented as an additional set of pages in the native technology and application programming interfaces (APIs) of the application server (e.g., JSP, Servlets, NET, etc.) that hosts the enterprise application 14. The web service 12 manages:
(i) Security: Web service 12 handles authentication of the client 10 and encryption (if used) of each message passed between the application server and the client 10 using the underlying security model of the enterprise application 14.
(ii) Communication: Messages may be passed using http/mail protocols, react and respond (“pull”) protocols, or through the initiation of new messages (“push” technology). For example, messages from the server to the client can be pushed by e-mail in a procedure in which the application server hosting the enterprise application 14 sends information to the client 10 as e-mail messages with an (optionally) encrypted XML attachment. When the e-mail is received at the client 10, the client recognizes and processes the message. Alternatively, or in addition, server-to-client messages may be pulled by the client with a web request. Messages from the client 10 to the enterprise application 14 can be sent directly with a web post, much like interacting with a regular web page. This is appropriate when the user is on-line and has access to the application server hosting the enterprise application 14. Alternatively, or in addition, such messages can be sent as an e-mail message with an (optionally) encrypted XML attachment along with any supporting documents or spreadsheets. This e-mail will be buffered in the desktop's outbox like any other outgoing message until the user synchronizes his/her e-mail. When the e-mail message eventually arrives at the application server, it is processed and any response is sent back to the client 10 using the mechanisms described above. Push and pull events may occur in response to the expiration of a timer or similar trigger.
(iii) Transformation: Web services 12 converts server-side constructs (e.g., action items, projects, etc.) written in the native object model of the enterprise application 14 into the client's representation for desktop objects (e.g., tasks, folders, etc.). This representation is extensible based on the needs of the application.
(iv) Offline caching: Web service 12 bundles any additional information (e.g., documents, server-generated forms, web page graphics, policy descriptions, etc.) into the server-client messages so the client 10 can interact with the enterprise application data when off-line.
(v) Input processing and validation: Web service 12 receives any client-initiated inputs and passes them back to the enterprise application 14. These inputs are transformed from desktop constructs back to their server-side equivalents. The enterprise application 14 can accept, reject, or modify these requests, (if for example the information that was cached on the desktop no longer matches the latest sever managed values) and the new state of the objects (as determined by the enterprise application 14) will be resynchronized to the client 10.

In operation then, the client 10 and web service 12 cooperate to pass information regarding objects (and changes thereto) between the desktop environment 22 and the enterprise application 14. Based on information from the enterprise application 14, the client 10 creates native objects in the various desktop applications including tasks, calendar items, calendars, contacts, folders, documents, and/or spreadsheets. With these full native desktop objects, all desktop application behavior is available (e.g., the objects can be synchronized with a personal digital assistant (PDA), popup reminders may be displayed, and the ability to forward the objects to other users is retained). Any application specific object extensions may be encoded as an additional XML attachment hidden in each object. Further, a single server (i.e., enterprise application) construct can be managed as multiple synchronized desktop objects (e.g., a single document review action item can be represented by a task, one or more calendar items on multiple different calendars, and in the document itself) and vice-versa. In addition, new menu items may be created per application, per document, and/or per object, which allows the user to initiate new actions.

In some cases, the enterprise application 14 may update the state of the desktop environment 22 according to changes that occur to the server-side objects. That is, changes to objects that are not yet reflected in the state of those objects at the desktop 22 may be communicated from the enterprise application 14 to the client 10 so that the updated state is available. In other cases, where the changes have occurred at the desktop 22, the “before and after” states of the objects (i.e., the object state as reflected in the most recent synchronization as well as that reflected by the most recent actions at the desktop 22) are communicated to the enterprise application 14. The enterprise application 14 may then accept, partially accept or reject these changes and communicate the updated state of the objects to the client 10.

Thus, the present invention involves more than just synchronization of objects (as might be the case with desktop and handheld applications, for example) and more than just linking of network-based content into desktop documents and spreadsheets for review. Instead, the present invention provides a form of “smart synchronization” in which objects and their associated server-defined behaviors are communicated to the desktop environment 22 and a form of active task handling, allowing the user to manipulate the objects once they have been synchronized, in which local interactions with the objects are processed in accordance with the server-defined behaviors.

The desktop environment 22 also includes a conventional web browser 24, which in some instances may be used as a separate interface for enterprise application 14. Indeed, in the absence of client 10, the web browser 24 may be used as the user's primary interface for enterprise application 14, as is customary in the art. However, in the context of the present invention, web browser 24 has a special function in that it is used locally (i.e., at the desktop 22) as a player for the web forms discussed above. These web forms are one example of server-managed, client-resident objects, policy, forms, and templates to facilitate communication between the enterprise application 14 and the desktop applications (e.g., calendaring application 16, word processing application 18 and/or spreadsheet application 20) that are part of the present invention.

In addition to playing web forms in a browser, other server-defined behaviors can be played by the client 10. For example, in some applications these behaviors may involve playing flash or other multimedia presentations, launching other desktop applications, checking for security access authorizations, installing and/or running scripts, or a host of other behaviors (including initiating communication with another client at another desktop). The combination of smart synchronization and active task handling thus provides for the projection of a complete range of server-based information and interactions to the desktop, and in a way where a wide range of interactions are possible when the user is not online

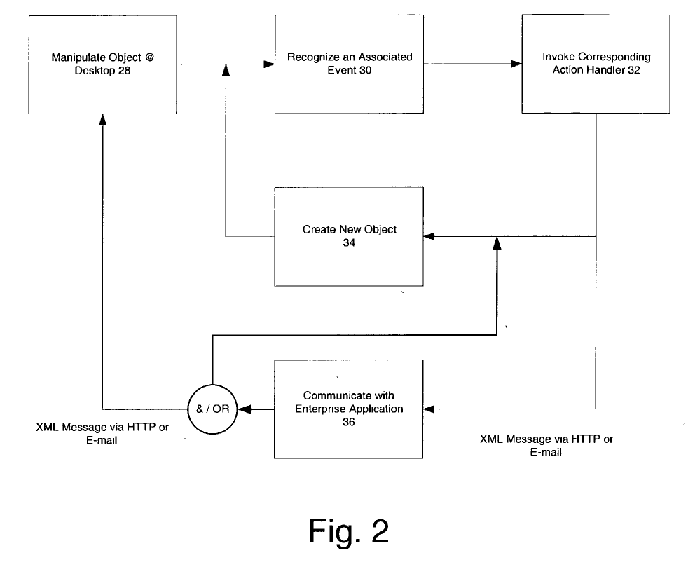

FIG. 2 illustrates the basic processes performed by the client 10 and the server-side web service 12. This basic object-event-action flow 26 is used regardless of the type of object under consideration. Thus, these procedures can apply to objects such as tasks, spreadsheets and documents as well as attributes of these objects such as the font used within a given spreadsheet cell. It is one of the features of the present invention that any desktop object (and here the term object is meant to include an attribute) that can be represented in an XML format can be recognized and managed by the client 10 and server-side web service 12. Managed objects, that is those for which associated action handlers are defined, (at any level) may be identified by appropriate indicators in the object's properties.

The basic flow 26 assumes that some form of synchronization between the enterprise application 12 and the desktop environment 22 has already occurred. This process is discussed further below. For now it is sufficient to recognize that during the synchronization procedure, not only are the objects themselves communicated from the enterprise application 14 to the desktop 22, so too are the server-defined behaviors (represented by the action handlers) associated with those objects. The objects and action handlers (along with any corresponding web forms that are played by the action handlers) are cached locally at the client 10 so that true off-line interaction with the objects can occur.

The client 10 represents the information required for off-line use in several ways. Objects such as calendar items and tasks may be stored as native desktop application (e.g., Word, Excel, Outlook, etc.) objects, with the additional extensions utilized by the client 10 and/or web service 12 stored as a hidden object attribute. Documents associated with an object may be stored as attachments on that object. Spreadsheets may store client-specific information in a specially named sheet in a workbook. Word processor documents may maintain their client-specific information in hidden properties of the document. The locally cached web forms and their associated HTML assets (e.g., images, style sheets, etc.) are preferably managed by the client 10 in a reserved area of the local file system.

Once the synchronization has occurred, manipulating an object at the desktop (see step 28) will cause an associated event to be recognized (see step 30). The manipulation may be any recognizable desktop interaction. For example, closing a document or spreadsheet may be such a manipulation. So too may be changing the content of a spreadsheet cell or even changing the font used in a document or spreadsheet. Indeed, any action that a user can perform using a desktop application can be a defined event that is processed according to the procedure illustrated in FIG. 2.

When the client 10 recognizes such an event (step 30), the client 10 invokes an action handler associated with that event (see step 32). The action handlers are local instantiations of the server-defined behaviors for the objects, according to the events being recognized. That is, the action handlers specify the permitted actions for an object according to the type of event being recognized. Instead of allowing the desktop application to complete its normal action associated with the event (e.g., such as closing a document when a user selects the “close” button in a word processing application), the client 10 captures the action and plays the associated server-defined action handler for that event. Such an action handler may specify options in addition to (or in place of) those normally performed by a desktop application and may include displaying one or more web pages (forms) in web browser 24 allowing for user input/interaction.

This functionality is made possible through the client 10, which exploits existing APIs provided by desktop application developers such as Microsoft Corporation. These developers expose the desktop applications through these APIs allowing third-party software developers (such as the assignee of the present invention) to integrate other software products with the desktop applications. In the present case, the client 10 is integrated into the event flow within the desktop applications so that customary operations performed by the desktop application are interrupted, displaced or extended by server-defined actions instantiated in the form of action handlers that are communicated to the client 10 during a synchronization process. The rules regarding these behaviors are those that would otherwise be applied by the enterprise application 14, thus the desktop applications are allowed to fully exploit the behavior of the enterprise application while at the same time providing a familiar (and powerful) operating environment for the user.

The client 10 can implement its visual interfaces with server-defined web forms, that are cached and presented locally using extensions to the desktop's web browser 24. In other embodiments, the client 10 may also play web forms resident at the application server. Although this does not allow for off-line use, the integration with the desktop environment is preserved.

Whether cached locally at the desktop or played from the application server, the web forms can be defined and generated on the application server with the enterprise application's native web page generation tools, and will have the complete look, feel and branding of the enterprise application 14. Since some or all of these forms may be needed when the user is offline, this invention provides extensions to the standard browsers to enable binding the presentation to the data attributes of the object being manipulated locally on the desktop, and to implement business logic or extended interactions across zero, one, or more interaction pages, and zero, one, or more messages back to the server. For example, these web forms can be used to present information (e.g., a document's history, a checklist for completing a spreadsheet, etc.), gather information (e.g., status updates on a project, comments in a review, etc.), or provide a user with additional options (e.g., save a document, finish a review, escalate an issue, etc.) whenever the user is interacting with a desktop menu, object, or document. As indicated above, some implementations will use only a few off-line enabled forms, with all other desktop interactions with objects linking back to web pages on the application server. In such cases, the client 10 can initiate a secure, automatic login procedure to the enterprise application 14 when the user is on-line, and display a graceful “unavailable” message when the user is off-line. In other cases, application developers may choose to build a substantial amount of logic into these locally cached web forms so that the user rarely, if ever, needs to connect back to the application server hosting enterprise application 14.

In addition to playing the locally cached web forms, action handlers may save attached documents (e.g., attached to a Microsoft Outlook Task or Calendar object), launch another desktop application on attached documents, send a secure message either by e-mail or over the Internet, follow a web link back to the enterprise application 14 when available, and/or perform other server-defined actions. In Microsoft Excel, for example, an action handler that enables data transfer in either direction between a spreadsheet and the enterprise application 14 may be included. In Microsoft Outlook, for example, action handlers may further provide the ability to synchronize task and calendar objects with the enterprise application 14 and to initiate other action handlers based on open, check-off, reschedule, and delete events on those objects. Configurable menus in Outlook and Excel may be linked to such action handlers.

As shown in the illustration, two common results of processing an action handler are the creation of a new object (see step 34) and/or communication with the enterprise application 14 (see step 36). Such communication may occur in a variety of ways. For example, if the user is on-line, the communication may be immediate by way of an XML message transported via HTTP over an existing network connection. Alternatively though, whether the user is on-line or off-line, the communication may take place using an XML attachment to an e-mail message. This e-mail message may be communicated between the desktop 22 and the enterprise application 14 using the user's conventional e-mail handling tools (e.g., which may be part of a calendaring application such as Microsoft Outlook).

The XML message informs the enterprise application 14 of the object that was manipulated, the attributes of that object that were presented to the user, and any changes to that object based on what was done by the user. In response, the enterprise application 14 may return an updated view of that (or any other) object, including the creation of new objects, or some other message (including an instruction not to so modify the object if the modification conflicts with some other change to the object that the enterprise application 14 is aware of). This return communication (which can be regarded as a form of synchronization) may also occur via e-mail or other means, for example depending upon whether the user is on-line or off-line. In the situations where the action handler creates one or more new objects (see step 34), these objects may undergo manipulation, and the above process repeats.

By creating local objects (e.g., tasks, spreadsheets, etc.) with their corresponding events and actions, the present invention allows an enterprise application 14 to prompt a user to action. By creating new menu items and their action handlers, users are also allowed to proactively initiate new objects or events. For example, a new menu choice in a word processing application 18 may allow the user to “capture” an unmanaged document and submit it to an enterprise application 14. From a calendar/task handler application 16, the user can initiate new activities or tasks such as a form-based request for assistance or a spreadsheet-based expense report. From a spreadsheet application 20, a spreadsheet can be enhanced with new menu items to present a checklist of sign-off steps, to request updated information from a server, or to submit data from the spreadsheet to the enterprise application 14 with an XML message. Each of these menus is configured with policy defined by the enterprise application 14, and can be customized to every desktop application and to every object type. The present invention supports the same action handlers for menu items as it does for all other objects—for example launching a desktop application, following a link to the enterprise application, sending a message, or presenting a locally cached form, which, in turn, can provide a vehicle for a user to perform any combination of the listed actions.

Optional security and integrity infrastructure enhancements provided by the present invention extend industry-standard mechanisms to protect data, communications and the script execution environment for cached forms and behaviors. Initial key exchanges may occur over HTTPS (secure hypertext transfer protocol). Key generation and storage is managed by the enterprise application 14. At the client 10, this key, which is never shown to the user, may be stored in the encrypted Outlook/MAPI store or in another secure manner. Access to the key would then require the user to authenticate to Outlook or the appropriate store, but would not require the user to remember any additional passwords. The user's web access credentials need never be communicated to the client 10. Asynchronous SMTP (simple message transport protocol) communication through multipart MIME (multipurpose internet mail extensions) messages can encapsulate attachments encrypted with the user's key and other optionally encrypted assets, documents and DHTML forms. Additionally, messages can be both digitally signed and encrypted to ensure that each side of a transaction (client and server) knows what entity sent a particular message, and that the received message is exactly what the sender transmitted. Of course other forms of security infrastructure may be used.

During synchronous exchanges, HTTPS can be used to communicate between the client 10 and enterprise application 14 to ensure delivery to only the intended end point. XML and other sensitive data components may also be encrypted with the user's key. Assets that are encrypted during transfer can remain encrypted on the client 10 to maintain their integrity after distribution. The client 10 processes any server specified behaviors in a script execution environment that enforces the default desktop security policies, protecting the user from unauthorized software and ensuring no greater access to the user's personal computer than is available to any other online application. The functionality of the present invention does not depend on local macros or on support for ActiveX scripting which are the source of security concerns. In many enterprises, these desktop capabilities are explicitly disabled because of the risk of viruses or other malicious code.

An additional security enhancement provided by the present invention involves a new client-server security model. Consider that some desktop applications permit users to protect an object (e.g., a document, spreadsheet, etc.) by specifying a password that is necessary to open and/or modify the object. Customarily, these passwords are assigned by human operators, but the present invention would allow for the password to be assigned by an enterprise application directly. That is, no human operator may ever know the object's associated password.

When the object is downloaded to a desktop environment, it is accompanied by an action handler, or a predefined policy of the client that specifies that the application seeking to open a document must contact the enterprise application for the correct password in order to do so. This may involve transmitting a user identification string or a previously defined key as described above to the enterprise application. If this identification string is determined to correspond to an authorized user, then the object password is returned by the enterprise application and the action handler completes the opening of the document. Otherwise the user is not permitted to access the document. If the user is off-line and attempts to open the document, such access may be denied (and a message displayed to inform the user that only on-line access is permitted) or the document may be unlocked by the client in some less then fully functional manner (e.g., confidential portions may be redacted or no modification permitted) based on a cached password that was previously acquired from the enterprise application.

In this security model, document control is managed according to server-defined behaviors (e.g., the list of authorized users), but document interaction still occurs using the familiar desktop tools (e.g., a word processing application). In addition, immediate security upgrades and/or modifications can be accomplished simply by changing server-managed/server-based lists, without having to inspect/access individual user desktops.

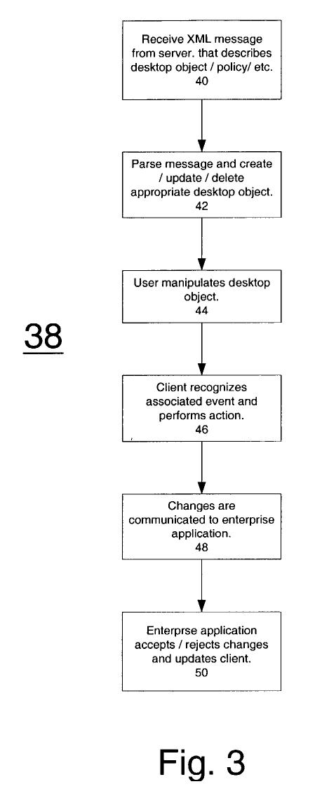

An example of the operation of the present invention involving the Microsoft Outlook application after installation of the client plug-in is illustrated in FIG. 3. This process 38 is but one example of how the present invention can extend an enterprise application to a desktop environment and is presented so that a reader might gain a better understanding of the operation of the invention. It should not be read as limiting the scope of the invention in any way.

The client receives an XML message from the enterprise application that describes any desktop objects, policy, attached documents, and DHTML forms (step 40). Each object definition is based on the desktop application's object definition, and can be arbitrarily extended with additional attributes. At step 42, the client parses the message and creates/updates/deletes the appropriate desktop objects (e.g., tasks, events, folders, contacts, menus, and caches).

When the user manipulates any of these objects (step 44), the client recognizes the action and initiates the action handler associated with that event (step 46). Each object/event can have a different handler (e.g., specific handlers for reschedule vs. open, multiple tasks each with a different check-off handler, etc.). If no action handler is specified, the behavior defaults to the customary Outlook action(s) as if the object was not a managed object.

Assuming an action handler is invoked, that action handler can launch other desktop applications, send a message, or present a locally cached DHTML form via the user's web browser. The DHTML forms are created and configured at the application server much like any other enterprise application web page, but are designed to execute locally by accessing the client extensions to browser hosted script environment/document object model (DOM) including:
(i) Access to the underlying object, enterprise application data pertaining to the object and the user-initiated event for contextual information about the current interaction.
(ii) Ability to modify the object to capture user input, with automatic support to maintain both the “before” and “after” version for the enterprise application.
(iii) Ability to undo/commit actions, guide the communication, and to launch other applications.

The changes requested by the user are sent to the enterprise application (step 48), either directly or in an e-mail message. The enterprise application has the final control over what changes are actually made to the “true” application objects and the updated state of those objects will be resynchronized to the client as the cycle begins again (step 50).

The following are a summary of features of one embodiment of the present invention in the Microsoft Outlook context:

1. Task and calendar synchronization and action handlers: The present invention provides for dynamic, bi-directional synchronization of tasks and calendar items between the desktop calendaring application (Outlook) 16 and the enterprise application 14. This is possible because managed objects can define all native Microsoft Outlook object attributes and arbitrary extended properties. Thus, where appropriate, a single server object can be represented by both task and calendar (and other) objects. Task objects can have action handlers for open, check, and delete events; while calendar objects can have action handlers for open, reschedule, and delete events.

2. Outlook Today as Dashboard: As is the case when being used simply as a personal desktop application, the native “Outlook Today” screen can be used to organize and complete tasks. Thus, the familiar user desktop environment is maintained while at the same time the underlying enterprise application behavior is exposed through the use of action handlers.

3. Configurable Menus: Menu in main Outlook screen minimally supports: about, synchronize, new, etc.; Menu in Task and Calendar viewer minimally supports: about, capture; Menu can appear at top level, or as additional buttons; Menus can be locally configured with standard “customize” option in Outlook; “New” menu can be used to launch applications based on cached templates (e.g., a new expense report based on a cached spreadsheet template).

4. Direct manipulation of local objects can trigger action handlers: Thus, calendar items can be rescheduled simply by moving them, and managed tasks and calendar items can be deleted in the customary fashion.

5. Capturing unmanaged objects: By selecting a menu item, unmanaged tasks and calendar items can be captured (e.g., by completing a configuration form that is played by an action handler in response to recognizing a “capture” event). When the request is processed by the enterprise application, the new object will be managed like all other managed objects.

6. Contacts and action handlers: The server can insert/update new contacts into the user's contacts folder; contacts can have action handlers for edit and delete; unmanaged contacts can be captured.

7. Hierarchical, Typed Folders: The enterprise application can create additional nested folders in a user's Outlook hierarchy. These folders can be of any supported type (Calendar, Tasks, Contacts, Messages, etc.). Objects can be synchronized into specific folders and the folder views can be customized (e.g., to only show tasks for a specific project, etc.).

8. Multiple Calendars: Even though Outlook requires that each calendar maintain independent events, the present invention can synchronize a single logical event across multiple calendars. This is especially useful when a user's personal calendar is synchronized with the user's personal events, while supporting an additional calendar per project that contains a rollup of all events for all users within a single project.

9. Folder Home Page: A folder's default view can be replaced with a locally cached web page. The page can be straight HTML generated by the enterprise application and transmitted and cached by the client, or can additionally reference the client DOM extensions and additional script (e.g., JavaScript and/or Visual Basic) calls to dynamically add content.

10. PDA links: Managed objects can be synchronized to a PDA in the same way as any other unmanaged objects.

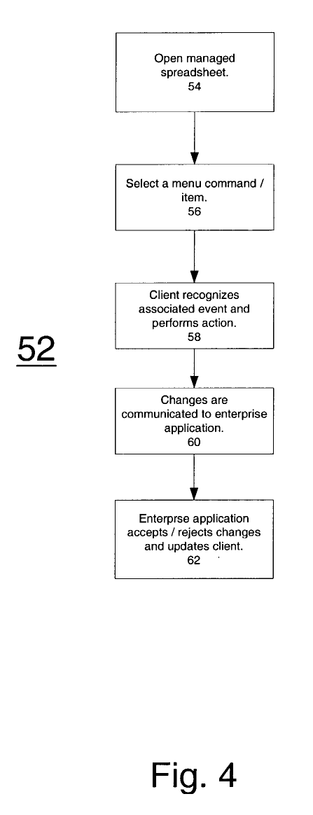

An example of the operation of the present invention involving the Microsoft Excel application is illustrated in FIG. 4. This process 52 is but one example of how the present invention can extend an enterprise application to a desktop environment and is presented so that a reader might gain a better understanding of the operation of the invention. It should not be read as limiting the scope of the invention in any way.

After installing the client and establishing credentials with the enterprise application, a managed spreadsheet can be opened at the desktop (step 54). Any spreadsheet can be enabled (that is modified to become a managed spreadsheet) by adding a new sheet to a workbook named with a designated client keyword, or through other means. This sheet can be hidden and should contain the XML commands that configure the client, along with any supporting information. The client can be configured to create a new menu items, invoke locally cached DHTML forms, manage secure communications to download data into Excel, and to upload new data back to the enterprise application.

When a managed spreadsheet workbook is opened, the client can add an appropriate indicator to the title bar, and create any specified menus. When the user selects one of these menu items (step 56), the client initiates the corresponding action handler (step 58). For example, a spreadsheet may include a “submit” action that will construct an XML message from key data in the spreadsheet, and send that message (optionally along with a copy of the spreadsheet) to the enterprise application server (step 60). The enterprise application may then resynchronize with the client to reflect these changes (if accepted) and/or other changes that have occurred since the last synchronization event. Additionally, data can be downloaded from the enterprise application directly into the managed spreadsheet.

A spreadsheet can also be configured with event/action behaviors tied to particular cells. For example, when a cell is modified, a form that requests the user describe the reasons for this edit can be automatically presented, with the reasons for the change stored in a hidden area of the spreadsheet and appended to any data “submit” message sent back to the enterprise application. This may help in keeping a revision history for the spreadsheet.

The following are a summary of features of one embodiment of the present invention in the Microsoft Excel context:

1. “Coded” Sheet: The present invention manages any workbook with a coded worksheet. Cell A1 (or another cell) on the coded worksheet should contain an XML command to configure the behavior of the client for that spreadsheet. The XML command can contain directives to create new menu items, to associate action handlers with those menu items, and to guide data import and export from/to the enterprise application. The coded worksheet can also be used to reference data throughout out the workbook and to marshal the information into XML messages to the enterprise application.

2. Security: No macros are necessary to leverage the functionality of the present invention, and users can continue to operate with the most common macro-restricting security levels. Access to the client's credentials need not be attached to the spreadsheet but instead may be derived from the user's mail store. In that way, if the user e-mails a spreadsheet, the recipient will have no credential information about the sender. When data is imported or exported between the spreadsheet and the enterprise application, the client manages secure communication with single sign-on.

3. Facilitated Download Into Excel: Excel has a built-in ability to fetch external data (e.g., through execution of the menu command Data:Import:WebQuery). The present invention significantly enhances this capability by (i) defining new menu items to initiate and configure the download; (ii) presenting cached web forms where the user can refine the download request; (iii) automatically logging in to the application server to actually fetch the data; and (iv) supporting web-based forms to provide feedback or exception information during/following the download.

4. Excel as Input Tool: Excel can be a powerful tool to gather and prepare input to an enterprise application. The present invention enables this capability by: (i) defining new menu items to initiate and configure the submission; (ii) locally extracting and marshalling data into an XML message; (iii) presenting cached web forms for the user to refine or complete the request; (iv) automatically logging in to the server to actually submit the data; (v) optionally sending the message as an e-mail with an XML attachment; and (vi) optionally including the entire spreadsheet as part of the submission.

5. Dynamic Button Bar: The present invention can facilitate the creation of a dynamic button bar in a spreadsheet. Each button can be attached to any action handler. These buttons can add a process-oriented user interface to a data oriented spreadsheet. Exemplary buttons can include:
(i) an ability to import or export data using enhancements provided by the present invention;
(ii) a sign-off list for what needs to be done on the spreadsheet;
(iii) an ability to escalate issues to other users; and
(iv) hooks to online help or further information.

6. Standalone Excel-based Session: With the present invention, a user does not need to login to an application server but can conduct a complete session entirely through Excel. In addition, unmanaged spreadsheets can be captured to become managed spreadsheets.

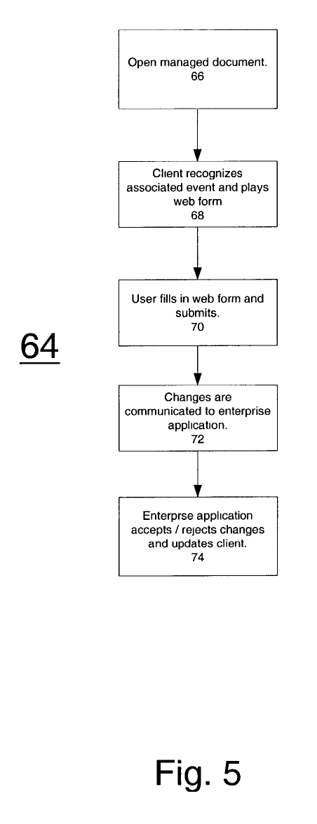

An example of the operation of the present invention involving the Microsoft Word application after installation of the client is illustrated in FIG. 5. This process 52 is but one example of how the present invention can extend an enterprise application to a desktop environment and is presented so that a reader might gain a better understanding of the operation of the invention. It should not be read as limiting the scope of the invention in any way.

After installing the client and establishing credentials with the enterprise application, a managed document can be opened at the desktop (step 66). If a document is not currently managed, the client may create a new menu item in Word that allows the user to “capture” the document and submit it to the enterprise application. Once under management, the document will contain additional hidden properties, which configure the client's behavior. When a managed document is opened, the client adds appropriate text to the title bar (optional), and creates any specified menus. Typical menus allow the user to submit an approval, create a new version, request additional reviewers, or view the document history.

When the document is manipulated in a fashion that involves a defined action handler, the action handler may bring up one or more local web forms (step 68), and when completed (step 70), can send both the user input, and the document itself back to the enterprise application (step 72). The enterprise application may then resynchronize with the client to reflect these changes (if accepted) and/or other changes that have occurred since the last synchronization event (step 74).

If a document is part of an action item, that fact is recorded in the document's properties. Since the information is stored (hidden) in the document, the user can save the document, or otherwise work on it when off-line. When ready, the user can complete the task directly from a menu in the word processing application rather than having to login to the application server, find the right web page, find the locally saved document, and upload it through the browser.

The following are a summary of features of one embodiment of the present invention in the Microsoft Word context:

1. Managed Documents: Managed documents may be assigned a custom property that contains tracking information. This tracking information can be used to:
(i) associate a document with a particular task;
(ii) record each time a client submits a new version; and
(iii) define additional buttons or actions for the document.
   Since the document “knows” where it is from, it can be saved, e-mailed, and edited off-line at the user's discretion. When a managed document is (re)opened in Word, the client recognizes it and allows the user to complete his/her outstanding tasks.

2. Capture a document: If a document is not managed, a menu option and an associated cached web form allow the user to capture the document and to submit it to the application server/enterprise application.

3. Complete Approval/Review: If a document is associated with a task, that task can be completed at any time directly from Word. When completed, Outlook, the enterprise application, and the document's managed properties will be updated. If the user is off-line, or the form developer desires asynchronous behavior, the new version of the document can be sent to the server by e-mail.

4. Document Tagging and History: Each time a new version of document is submitted, the enterprise application automatically adds a new history record to the tracked history of the document. The user can view the recorded history of each document to ascertain which version of the document he/she is working with.

5. Dynamic Button Bar/Menus: The present invention can allow a user to create a dynamic button bar for a managed document. Each button can be attached to any action handler. Exemplary buttons can include typical document workflow steps including:
(i) handing off a review to another person;
(ii) requesting an additional approval; and
(iii) linking to additional online help for that type of document.

The following example illustrates one application of the present invention. Consider a situation in which a sales executive for an organization is responsible for a few named accounts. In addition to his customer facing responsibilities, he must act as a project manager across multiple internal constituents (marketing, manufacturing, etc.) to prosecute his opportunities. His company has installed an advanced enterprise software application that can track customer information, process steps, and work-in-progress.

Assume further that some information in the enterprise application database must always be kept current to generate accurate pipeline forecasts, but the rest of the functionality provided by this software suite is not really useful since the other constituents do not want to interact with such a complex application. Rather than assist the executive in pursuiing his sales opportunities, the enterprise system becomes a data “sink” which must be loaded with information as an additional chore. The pipeline data is kept up to date by a sales administrator (e.g., based on spreadsheets mailed by the sales executive), but the rest of the enterprise application functionality is rarely used.

Using the present invention, several enhancements to this enterprise system are possible. First, where the enterprise system needs pipeline data entered and updated on a regular basis, the present invention can be used to integrate with both Outlook and Excel on the sales executive's desktop. Every week, for example, task and calendar items can be created to remind the executive he must provide updated information. When the executive selects (e.g., through a cursor control operation such as a mouse click) the task in Outlook, associated action handlers may automatically launch a spreadsheet template. This template may define additional behaviors to download the latest pipeline data from the enterprise application database (e.g., directly when online or via an asynchronous e-mail exchange), and to submit any changes or additions made to the spreadsheet. Copies of the spreadsheet can be maintained in an Outlook folder for future reference, or automatically sent to the executive's administrative assistant.

Second, a regional sales manager can use the present invention for her weekly task of reviewing the information submitted by each district manager and providing her own input, without ever leaving Excel. The associated spreadsheets can be processed while traveling, referencing the mostly recently synchronized data. The present invention tracks “before” and “after” values, so the forecasting application can correctly process (or reject) any new data based on outdated information.

Third, for constituents who are not regular users of the forecasting application, the present invention can automatically place tasks or action items assigned to them directly onto their familiar desktop calendars. For tasks that involve providing basic information or approving documents, the user can click on the task and be immediately presented with a simple web form to finish that task. If the user does not respond, a variety of Outlook reminder techniques are available.

Fourth, tasks that require approving or editing documents (e.g., a Statement of Work) can use the present invention's integration with a desktop word processing application. Users can complete their review directly from their word processing application, which can automatically update the enterprise system with the newest version of the document.

Fifth, for a team that is focused on a particular deal, the present invention can be used to create and synchronize a folder (or a hierarchy of folders) in Outlook that will contain the latest version of all the critical deal documents, contacts, tasks, etc. Additionally, for individuals who track their time spent on each deal, a personal Outlook calendar event can be created to represent every block of time so spent. The present invention can be used to capture this event, with all information being sent to the server for storage and tracking.

Sixth, spreadsheets that include valuable company secrets such as quarterly revenue projections can be secured with a password known only to the enterprise application. When a user with a valid account opens a secured spreadsheet, the client automatically unlocks that spreadsheet. However, if the user's account is disabled or her permissions are changed, they will no longer be able to access the information within the secured spreadsheet.

With these enhancements, the power of the enterprise application's workflow processing can be linked directly to how and where people are doing their work. Tasks that require viewing and submitting documents or spreadsheets can be done directly through familiar tools such as Excel and Word, and most tasks are fully functional for traveling users. The net result is that more people may use the enterprise application, more productively.

Thus, a scheme for integrating enterprise software applications with traditional single-user (i.e., desktop) software applications, such as the Microsoft Office suite of software applications, has been described. It should be remembered, however, that the examples described above are just that, examples, and are not meant to limit the broader scope of the present invention, which is reflected in the following claims.

1. A method, comprising:
projecting one or more constructs defined in a native object model of an enterprise application resident at a server into one or more corresponding objects associated with one or more desktop applications;
processing one or more types of interactions with the one or more desktop objects according to behaviors defined during the projecting; and
communicating the interactions with the one or more desktop objects to the enterprise application.

2. The method of claim 1 wherein the behaviors are processed according to action handlers cached at a desktop client.

3. The method of claim 2 wherein the action handlers are configured to save, modify or create an associated object, launch a desktop application, send a message to the enterprise application, provide a link back to the enterprise application, communicate with another client, and/or present a locally cached web form at the desktop.

4. The method of claim 3 wherein the locally cached web form provides a user with options for interacting with the one or more desktop objects according to the behaviors defined by the enterprise application.

5. The method of claim 2 wherein the action handlers manipulate the one or more desktop objects to alter a desktop environment without communicating such manipulation to the enterprise application.

6. The method of claim 1 wherein a single one of the constructs of the enterprise application is projected to multiple ones of the corresponding objects associated with one or more desktop applications.

7. The method of claim 1 wherein a single one of the constructs of the enterprise application is projected to a corresponding object associated with multiple ones of the desktop applications.

8. The method of claim 1 wherein multiple ones of the constructs of the enterprise application are projected to a single one of the corresponding objects associated with one or more desktop applications.

9. The method of claim 1 wherein the interactions with the one or more desktop objects are communicated to the enterprise application via extensible markup language (XML) messages.

10. The method of claim 9 wherein the XML messages comprise e-mail attachments.

11. The method of claim 9 wherein the XML messages are sent via a secure communication channel.

12. The method of claim 1 wherein the interactions comprise manipulation of the one or more objects with the one or more desktop applications at a time when the desktop applications are not communicatively coupled to the enterprise application

13. A system, comprising: a client application configured to (i) recognize events corresponding to manipulations of objects within one or more desktop applications within a desktop environment, said objects being projections of constructs defined in a native object model of an enterprise application resident at a server, and (ii) invoke one or more action handlers to respond to the events according to behaviors defined by the enterprise application.

14. The system of claim 13 wherein the manipulations comprise creation of the objects.

15. The system of claim 13 wherein the events comprise receipt of messages from the server, actions by a user and/or expiration of a timer.

16. The system of claim 47 wherein the messages comprise extensible markup language (XML) messages.

17. The system of claim 16 wherein the XML messages are transmitted using e-mail.

18. The system of claim 17 wherein the message processor is further configured to provide one or more web forms to the client application, which web forms are played by the action handlers in response to the events.

19. The system of claim 18 wherein the web forms comprise options for managing the objects according to the events recognized.

20. The system of claim 47 wherein one or more of the messages between the client application and the enterprise application comprise updates reflecting changes to the objects made within the desktop environment.

21. The system of claim 20 wherein the enterprise application is configured to accept, partially accept or reject the changes to the objects and to communicate such acceptance or rejection to the client application.

22. The system of claim 21 wherein communication of the acceptance or rejection includes a complete or partial description of objects related or unrelated to a changed object.

23. The system of claim 13 wherein the action handlers are configured to save, create or modify the objects, launch one of the desktop applications within the desktop environment, send a message to the enterprise application, provide a link to the enterprise application, communicate with another client, and/or present a locally cached web form within the desktop environment which can perform any number of these operations.

24. The system of claim 23 wherein the locally cached web forms comprise options for managing the objects according to the events recognized.

25. The system of claim 47 wherein the message processor is configured to convert the constructs written in the native object model of the enterprise application into extensible mark-up language (XML) representations used by the client application for desktop objects.

26. The system of claim 13 wherein the enterprise application is configured to update a state of the desktop environment according to modifications of the objects at the server.

27. The system of claim 26 wherein the update is based on a reconciliation of a server-state of the objects, a former desktop state of the objects and a current desktop state of the objects.

28. The system of claim 27 wherein the former desktop state of the objects is determined by a most recent transfer of messages regarding the objects.

29. A method, comprising:
receiving extensible mark-up language (XML) representations of enterprise application based constructs defined in a native object model of the enterprise application along with enterprise application defined behaviors therefor within a desktop environment;
projecting the XML representations of the constructs as one or more desktop application objects within the desktop environment;
recognizing events associated with the desktop application objects occurring within the desktop environment; and
invoking action handlers representing the defined behaviors.

30. The method of claim 29 wherein the action handlers are configured to save, create or modify the objects, launch a desktop application within the desktop environment, send a message to the enterprise application, provide a link to the enterprise application, communicate with another client, and/or present a locally cached web form within the desktop environment which can perform any number of these operations.

31. The method of claim 30 wherein the web forms comprise options for managing the objects according to the defined behaviors.

32. A method, comprising:
converting a representation of a construct associated with an enterprise application resident at a server from a native representation of the construct in the enterprise application to an extensible mark-up language (XML) representation thereof; and
projecting the XML representation of the enterprise application construct along with enterprise application defined behaviors therefor to one or more objects compatible with a desktop environment remote from the server.

33. The method of claim 32 wherein the behaviors are instantiated as action handlers within the desktop environment, which action handlers are invoked when events associated with the objects occur within the desktop environment.

34. The method of claim 33 wherein the action handlers are configured to save, create or modify the objects, launch a desktop application within the desktop environment, send a message to the enterprise application, provide a link to the enterprise application, and/or present a locally cached web form within the desktop environment which can perform any number of these operations.

35. A method, comprising:
in response to a manipulation of an object within a desktop environment, enforcing enterprise-application defined behaviors for the object to produce a modified object;
converting the modified object from a representation defined by the desktop environment to an enterprise application defined representation of the modified object, said enterprise application resident at a server remote from the desktop environment;
returning to the server from the desktop environment the enterprise application defined representation of the modified object along with an enterprise application defined representation of the object for reconciliation by the enterprise application.

36. The method of claim 35 further comprising projecting an updated representation of the object that accounts for the reconciliation from the enterprise application to the desktop environment.

37. A method, comprising:
projecting one or more constructs defined in an enterprise application resident at a server along with enterprise application-defined behaviors therefor into one or more corresponding objects defined for a desktop environment remote from the server;
recognizing one or more types of interactions with the objects; and
executing one or more action handlers within the desktop environment to enforce the enterprise application-defined behaviors.

38. The method of claim 37 wherein one or more of the action handlers is configured to communicate results of the interactions to the enterprise application.

39. The method of claim 38 wherein one or more of the action handlers is configured to play one or more web forms to provide users options according to the interactions.

40. The method of claim 39 wherein one or more of the web forms are available even when the desktop environment is not communicatively coupled to the enterprise application.

41. The method of claim 37 wherein at least one of the action handlers is configured to request a password from the enterprise application in response to an attempt to open or modify at least one of the objects.

42. The method of claim 37 wherein the action handlers are executed in accordance with security policies of the desktop environment.

43. A method, comprising enforcing enterprise application-defined access policies regarding a representation of a construct defined in a native object model of and received from the enterprise application and now resident as an object within a desktop environment remote from a server hosting the enterprise application by playing one or more action handlers invoked in response to a manipulation of the object within the desktop environment.

44. The method of claim 43 wherein at least one of the action handlers is configured to request a password from the enterprise application when the manipulation is recognized by a client application within the desktop environment.

45. The method of claim 44 wherein the password is not disclosed to a user.

46. The method of claim 44 wherein the password is communicated by way of a secure message between the enterprise application and the desktop environment.

47. The system of claim 13 further comprising a message processor instantiated at the server remote from the desktop environment and configured to receive and transfer messages between the client application and the enterprise application resident at the server, said messages defining the desktop environment objects in the object model of the enterprise application.

48. A method of accessing enterprise application resident information through a desktop environment, comprising projecting an object defined in a native model of the enterprise application into a corresponding desktop environment defined object, manipulating the object within the desktop environment according to enterprise application defined behaviors instantiated in action handlers stored in the desktop environment to produce a modified object, and communicating the modified object as defined in the native model of the enterprise application to the enterprise application.
